(19) United States
(12) Patent Application Publication
(10) Pub. No.: US 2007/0166489 A1
(43) Pub. Date: Jul. 19, 2007

(54) Internally reinforced tubular food casing containing protein

(76) Inventors: Jens Foegler, Taunusstein (DE); Herbert Gord, Ingelheim (DE); Michael Seelgen, Idstein (DE)

Correspondence Address: PROPAT, L.L.C., 425-C SOUTH SHARON AMITY ROAD, CHARLOTTE, NC, 28211-2841, US

(21) Appl. No.: 10/580,976

(22) PCT Filed: Nov. 11, 2004
(86) PCT No.: PCT/EP04/12769

§ 371 Date: May 31, 2006

(30) Foreign Application Priority Data
Dec. 19, 2003 (DE) 103 60 610.6

(51) Int. Cl. A22C 13/00

(52) U.S. Cl. 428/34.8

(57) ABSTRACT

The invention relates to a tubular food casing comprising a reinforcement which is coated on one or both sides. On at least one side the coating comprises at least one film-forming protein, in particular gelatin and/or collagen. Preferably, the reinforcement is a non-woven or spun-woven fabric, a tissue, a fabric, a layered or knitted fabric, which can be permeated by the coating containing protein. The food casing is preferably used as a synthetic sausage casing or cheese casing.

The invention relates to an internally reinforced tubular food casing and also to its use as artificial sausage casing.

Tubular food casings based on regenerated cellulose having an internal reinforcement of a fiber paper, in particular of hemp fiber paper, have long been known (see G. Effenberger, Wursthüllen—Kunstdarm, [Sausage Casings—Artificial Skin], 2nd edition [1991] Holzmann Buchverlag, Bad Wörishofen, pp. 23/24). They are generally used as artificial sausage casings. These casings are produced by the viscose method which comprises many process stages, is very complex in terms of apparatus and requires intense cleanup of exhaust air and wastewater.

As an alternative, the amine oxide method was developed. In this the cellulose is no longer chemically derivatized (as in the viscose method), but is dissolved purely physically in an aqueous amine oxide, in particular in N-methylmorpholine N-oxide (NMMO) monohydrate. The cellulose dissolved in the aqueous amine oxide can, as in the viscose method, be applied to a web-shaped fibrous material formed into a tube. The tube thus coated is then conducted through a bath having dilute aqueous amine oxide. In the bath the cellulose is precipitated. In this manner a seamless casing is obtained.

Casings having a longitudinal seam may be produced from a corresponding flat material by generally known methods such as gluing, sealing, sewing or the like. The flat material can itself be obtained by cutting open a large-caliber tube in the longitudinal direction and dividing the cut-open tube into parallel webs. Casings produced in this manner have a particularly uniform extension over the entire periphery.

Artificial sausage casings from flat fibrous material are also known, for example from a cotton tubular knit which is impregnated on the outside with collagen (DE-C 33 33 387).

JP-A 51-079748 discloses laminates made of a porous, web-shaped support material, for example made of paper, textile material or a porous film and a film made of water-soluble polysaccharides, proteins and/or synthetic resins. Suitable polysaccharides mentioned are, in particular, mannan, chitin, alginic acid and pectin. Examples of proteins mentioned are collagen, gelatin and casein, examples of synthetic resins are polyvinyl alcohol, polyacrylic acid, polyacrylamide and polyvinylpyrrolidone. The laminates are processed to form food casings, including sausage casings. The casings exhibit improved smokeability, high transparency and satisfactory strength. Laminates, however, frequently have the disadvantage that the adhesion between support material and film is not sufficient.

Tubular casings which are formed from a laminated or coated flat material have double the wall thickness in the region of the seam. Seam sites lying one over the other then, on being rolled up, form thick points (beads). On shirring, the thick seam regions lead to slightly bent shirred sticks. If the tubular casing is printed, in addition care must be taken to ensure that the printed image does not extend into the region of the seam, since this region cannot be printed properly.

Laminated or coated flat materials, however, may be produced more simply and thus more economically. They can be processed without problems to form casings having a seam. The advantages in the production of the casings outweigh the disadvantages associated with the seam.

The object was therefore to develop a food casing which no longer has the disadvantages described, or has them to a much lesser extent. It is to be able to be produced simply, inexpensively, and in an environmentally friendly manner. Its properties, in particular their water vapor and oxygen barrier properties, are to be settable over a wide range, so that the casing may be used for a multiplicity of different foods. It is also to be less susceptible, as far as possible even resistant, to cellulytic enzymes (cellulases) which are formed, for example, by molds. The casings, in addition, are to be producible without chemical regeneration in which reaction gases and de-swelling water are produced (which is always the case in the viscose method).

The objects described have been achieved by a coating based on protein which is applied uniformly externally and/or internally to a fibrous material formed into a tube. A further solution was that the coating based on protein is applied uniformly to one or both sides of a flat fibrous material.

The present invention therefore relates to a tubular food casing having a coated flat-shaped reinforcement insert which comprises at least one layer of at least one film-forming protein.

The flat-shaped insert is preferably a consolidated nonwoven or spunbonded fabric which may be impregnated.

The flat-shaped insert can also be impregnated on one or both sides after application of the protein-containing layer. The coated flat material or the tubular casing formed therefrom can be impregnated. By means of such an impregnation, for example the sausage emulsion adhesion can be set or the mold resistance increased. The impregnation can also comprise transferrable color, aroma, odor and/or flavor components (for example liquid smoke). In further embodiments the insert is a woven fabric, loop-formingly knitted fabric, loop-drawingly knitted fabric or laid fabric or else a porous film. The flat-shaped insert can comprise natural and/or artificial fibers. Preferred materials are cotton, regenerated cellulose (viscose staple), silk, polyester, polyamide, polyolefin (in particular polypropylene), polyvinyl acetate, polyacrylonitrile, polyvinyl chloride and also the corresponding copolymers. Mixtures of different materials may also be used (e.g. mixtures of viscose staple and polyester). All of these insert materials can be impregnated. An impregnation can be achieved, for example, by an adhesion promoter which improves the adhesion of the coating. The impregnating agents are used in a small amount, i.e. the amount is in no way sufficient to fill up the interstices of the flat-shaped insert.

The term “flat-shaped” is to be taken to mean materials which are relatively thin, but are self-supporting and may be formed into a tube. Thickness and weight per unit area are also dependent on the later use of the casing. Generally, the weight per unit area is 3 to 1000 g/m², preferably 10 to 130 g/m², particularly preferably 12 to 75 g/m². If the flat-shaped insert is a fibrous paper this preferably has a weight of 17 to 29 g/m². Depending on requirements, the support material is extensible or virtually inextensible. Inextensible flat-shaped inserts are useful for casings where particularly high caliber constancy is of importance. The insert may where appropriate comprise two or more identical or different layers, for example a fibrous paper, which is bonded to a textile material.

The insert is formed into a tube, the longitudinal edges being able to overlap to a greater or lesser extent. Depending on caliber of the casing, the overlapping region, however, is generally only a few millimeters wide. An overlapping region having a width of 1 to 6 mm, preferably from 1.5 to 4 mm, has proved to be expedient.

The insert formed into a tube is then uniformly coated externally, internally or from both sides, the layer or coating at least in part consisting of a film-forming protein. The insert can likewise be coated on one or both sides, before it is further processed into a tube. “Film-forming” means that the protein can form a continuous, coherent coating. Particularly preferred proteins in this case are gelatin or collagen. Very suitable proteins are also casein (milk protein), soybean protein, gluten (wheat protein), zein (corn protein), ardein (peanut protein), pea protein, cottonseed protein or fish protein. The protein, in particular gelatin, is preferably mixed with an inorganic or organic filler. Particularly suitable inorganic fillers in this case are chalk, limestone flour, calcite, precipitated calcium carbonate, magnesium carbonate, barium carbonate, dolomite and/or other mixed carbonates. Particularly suitable organic fillers are finely ground cellulose powder, wheat bran, native and/or thermoplastic starch (TPS) or starch derivatives. In the field of underivatized starch, preference is given to native and/or thermoplasticized corn and/or potato starch. Starch derivatives are, for example, starch esters, such as starch acetates, maleates, propionates, butyrates, lauroates or/and oleates, starch xanthogenates, phosphates, sulfates or/and nitrates, starch ethers, such as starch methyl ether, starch ethyl ether, starch propyl ether, starch butyl ether, starch alkenyl ether, starch hydroxyethyl ether or/and starch hydroxypropyl ether, grafted starches, in particular starch grafted with maleic or succinic anhydride or/and oxidized starches, such as dialdehyde starch, carboxy starch or/and starch broken down by persulfate. Further polysaccharides can also be present, in particular plant powders and/or fibers such as, inter alia, those from cotton, kapok, flax, linen, hemp, jute, kenaf, ramie, sisal, peat, straw, wheat, potatoes, tomatoes, carrots, coconut, pineapple, apples, oranges, spruce, pine or cork.

However, it must be stressed that the protein-containing layer or coating does not contain regenerated or precipitated cellulose, but it can, however, contain in minor amounts of less than 5% by weight, based on the weight of the layer or coating, of a finely divided cellulosic filler.

Gelatin is obtained by hydrolysis of bone protein or hide protein (generally from beef hide and bones), the triple-helical structure for the most part being destroyed. The molecular weight is about 15 000 to 250 000 g/mol, the molecular weight distribution corresponding to a Gauβian curve. Gelatin is substantially water-soluble. Collagen fibers are not generally present therein.

The protein can also be collagen or desamidocollagen, which is preferably mixed with collagen fibers. The fibers expediently have a length of 0.1 to 4.0 cm. The fraction of fibers is generally up to 80% by weight, preferably about 20 to 50% by weight, in each case based on the total weight of protein.

The protein fraction is generally 2.5 to 95% by weight, preferably 20 to 80% by weight, particularly preferably 30 to 75% by weight, in each case based on the total coating weight of the casing.

In addition to the protein, the coating can comprise further natural and/or synthetic polymers. These are, in particular, polyacrylates, polyvinyl acetates and/or (co)polymers having units of vinyl acetate, a greater or lesser part of the vinyl acetate units also being able to be saponified. These polymers can also have permanently plasticizing properties. Such compounds also termed “primary plasticizers” are, for example, alginates, polyvinylpyrrolidones, quaternary vinylpyrrolidone copolymers (®Gafquat), copolymers with units of vinylpyrrolidone, maleic anhydride, methyl vinyl ether or branched polysaccharides (such as carrageenan). The fraction of the further polymers is generally up to 50% by weight, preferably 5 to 40% by weight, particularly preferably 6 to 25% by weight, based on the dry weight of the casing.

If the film-forming protein is water-soluble, as is the case, for example, for gelatin, in addition at least one crosslinker is required. Suitable crosslinkers are epoxidized linseed oil, diketenes having long-chain alkyl radicals (generally having (C₁₀-C₁₈)alkyl radicals), caramel, tannin, diepoxides, citral, aziridines, compounds having at least two carbaldehyde groups (such as glyoxal or glutaraldehyde) and/or polyamine-polyamide-epichlorohydrin resins, acrylamides, bisacrylamides and acrylmethylol and also any mixtures thereof, e.g. acrylamide-methylol and bisacrylamide-dimethylol.

In a preferred embodiment, the casing has two protein-containing coatings lying one over the other. Thus, for example, the first coating can fill interstices in the flat-shaped insert material. A further continuous coating which can also contain another protein or another mixture of proteins is then applied thereon in a subsequent step. The protein mixtures preferably comprise collagen fibers.

The coating can in addition comprise dye and/or pigments. The fraction of dyes and/or pigments is generally 0.5 to 12.0% by weight, preferably 1.0 to 6.0% by weight, in each case based on the dry weight of the casing.

The casing may additionally comprise aroma substances, flavor substances or odor substances which can be transferrable to the sausage emulsion. Mention may be made here in particular of dry smoke or liquid smoke.

To prevent the casing from sticking together in the laid-flat and rolled-up state, it can comprise customary additives in minor amounts (i.e. of maximum about 10% by weight, based on the dry weight of the casing). Such additives are, for example, aluminum silicates, in particular kaolin, calcium carbonate, silicon dioxide, a PVC pigment, waxes or fatty oils. Other additives can serve for ensuring the desired extent of sausage emulsion adhesion. If the protein fraction is not sufficient for this, then a customary internal impregnation is to be performed, such as, e.g. the formulation comprising 40% ®Aquapel, to achieve a release action.

Expediently, the inventive casing in addition further comprises at least one secondary plasticizer, preferably glycerol.

In addition to the protein-containing layer or coating, the inventive casing can also have further layers. These generally do not comprise regenerated or precipitated cellulose either. Layers which can additionally be present are in particular those based on polyacrylate, polyvinyl acetate (PVA), polyvinylpyrrolidone, polyvinylidene chloride (PVDC), polyvinyl chloride (PVC), ethylene/vinyl alcohol copolymers (EVA), ethylene/acrylic acid copolymers, polyvinyl alcohol (PVOH), synthetic rubber, latex, silicone or any mixtures thereof. The additional layers can also comprise the customary additives, in particular dyes and/or pigments. These further layers are formed as continuous layers on the tubular support material or on the flat material. One or more of the further layers can also be applied to the protein-containing layer. For instance, first a polyacrylate layer, and then a gelatin layer, can be applied to the web-like support material. By suitable choice of type, number and thickness of the additional layer(s), the oxygen and water vapor permeability of the inventive casing can be set in a broad range, so that it may be used for various types of foods.

An additional PVDC layer gives the casing a particularly high water vapor and oxygen barrier, thus preventing the sausage from drying out and discoloration of the sausage emulsion by oxidation (e.g. in the case of liver sausage). The PVDC layer preferably forms the outer layer.

The thickness of the coating(s) is selected in such a manner that the casing has the water vapor and oxygen permeability required, for example, for ripening the sausage. Generally, the weight of the casing after drying is 10 to 200 g/m², preferably 20 to 120 g/m², particularly preferably 30 to 100 g/m².

The casing generally has a water content of about 6 to 20% by weight, preferably about 8 to 12% by weight. The inventive casing can then be premoistened (to a moisture fraction of about 20 to 30% by weight) and delivered in this state to the sausage manufacturer, or be soaked before stuffing by the manufacturer himself. Surprisingly, it has been found that the inventive casing can also be stuffed without problems without previous moistening or soaking.

The inventive food casing has a water vapor permeability (as specified in DIN 53 122) of 300 to 1500 g/m²d, preferably 700 to 1100 g/m²d. Its oxygen permeability is generally 700 to 1500 cm³/m²d (determined as specified in DIN 53 380 at 65% r.h.), measured on a 5 cm² size piece of the casing having a water content of 8 to 10% by weight and a plasticizer content of about 15% by weight.

The water permeability is generally about 10 to 100 l/m²d, preferably about 12 to 20 l/m²d at 40 bar.

Depending on composition and thickness of the coating, the casing can also be smoke-permeable. The yield behavior of the casing is likewise determined by the type and thickness of the coating, but in addition also by the type and thickness of the flat-shaped reinforcement insert. For instance, the extension can vary between 0.1 and 25%, preferably between 1 and 5% (respectively in the longitudinal and transverse direction).

Methods and apparatuses for producing the inventive casing are known per se to those skilled in the art. In this case a web-like support material of a predetermined width is first formed into a tube, for example by what is termed a form shoulder. The tube, to maintain its shape and to avoid drying shrinkage, is charged with supporting air or held in its round shape by caliber support rings. Subsequently the support material is internally and/or externally seamlessly coated with the protein-containing composition, for example using a ring-slot die. The coating material (at least the first coating) permeates the flat-shaped insert and thereby bonds its (overlapping) longitudinal edges firmly together. In the seam region of the support material the casing is then only insignificantly thicker than in the remaining regions.

The casing can if appropriate be cut in the longitudinal direction into two or more webs which may be subsequently closed by gluing, sealing, sewing or in another manner familiar to those skilled in the art to give tubes of correspondingly smaller diameter. The resulting casings having a longitudinal seam may likewise be used as food casings, in particular as artificial sausage casings.

In a particular embodiment, the web-like support material is coated on one or both sides, for example by spraying, doctor knife application, roll application, application using a wide-slotted die or by another coating method familiar to those skilled in the art. The coated flat material is if appropriate printed. If required, the coated flat material is cut into webs of appropriate width, the webs are formed into tubular casings in a manner known per se and the overlapping longitudinal edges are fixed, for example by gluing, sewing, sealing or welding. For the glued seam, for example hotmelts, reaction glues or proteins can be used.

The inventive casing may be stuffed with pasty foods, in particular with sausagemeat emulsion, using conventional stuffing machines. When used as sausage casing, it is expediently used in shirred form (as what is termed a shirred stick) or in the form of individual sections. The individual sections in this case are closed at one end, for example by a metal or plastic clip, by tying off with yarn or by sewing. The sections are then individually pushed onto the stuffing horn of the stuffing apparatus, stuffed with sausage emulsion and closed. Further processing can then proceed as customary by scalding, cooking, smoking, ripening, etc.

Part of the present invention is accordingly also the use of the inventive casing as artificial sausage casing, in particular for raw meat sausage, scalded-emulsion sausage or cooked-meat sausage, or as casing for cheese.

The examples hereinafter serve to illustrate the invention. Percentages are percentages by weight, unless stated otherwise, or is clear from the context.

### EXAMPLE 1

A fibrous nonwoven made of hemp fibers having a weight of 19 g/m² was formed into a tube having a diameter of 40 mm having overlapping longitudinal edges (=caliber 40). The tube was then coated on the outside using an annular coating system with the following mixture:

| | |
|---|---|
| 50.0 kg | of water |
| 5.0 kg | of finely ground chalk |
| 30.0 kg | of gelatin |
| 1.0 kg | of epoxidized linseed oil (® Edenol B316 Spezial |
| | from Henkel KgaA) |
| 1.5 kg | of CMC (carboxymethylcellulose Na salt) |
| 3.0 l | of isopropanol |

After coating, the tube was dried by hot air in the inflated state, then laid flat and wound up. The weight of the coating was thereafter determined at 60 g/m². The casing was able to be shirred without problems and stuffed with sausage emulsion on an automatic stuffing apparatus.

A casing stuffed with salami emulsion exhibited a weight loss of about 20% in the course of 10 days.

### EXAMPLE 2

A textile woven fabric made of a cotton/polyester mixture having a weight of 102 g/m² was formed into a tube having a diameter of 60 mm having overlapping longitudinal edges and coated on the outside with a ring-shaped doctor knife with a mixture of

| | |
|---|---|
| 75.0 kg | of water |
| 7.5 kg | of cellulose (pulverulent) |
| 45.0 kg | of gelatin |
| 0.7 kg | of glyoxal |
| 1.5 kg | of ® Edenol B316 Spezial |
| 2.25 kg | of CMC (carboxymethylcellulose Na salt) and |
| 4.5 l | of isopropanol. |

The coated casing was dried in the inflated state with hot air, then laid flat and rolled up. After drying the weight of the coating was 80 g/m².

### EXAMPLE 3

A flat-shaped support material made of a cotton/polyester mixture having a weight of 58 g/m² was formed into a tube having a diameter of 40 mm having overlapping longitudinal edges (=caliber 40) and externally coated with a mixture of

| | |
|---|---|
| 30.0 kg | of DAC (desamidocollagen) |
| 3.0 kg | of cellulose (pulverulent) |
| 5.0 kg | of glycerol and |
| 1.0 kg | of ® Edenol B316 Spezial |

and dried as described in example 1. The casing thereafter had a weight of 150 g/m² and a stuffing caliber of 60 mm. It was then stuffed with liver sausage emulsion. On stuffing, an extension of 5% was determined.

### EXAMPLE 4

A fibrous nonwoven made of hemp fibers having a weight of 21 g/m² was formed into a tube having a diameter of 40 mm having overlapping longitudinal edges (=caliber 40). The tube was then coated on the outside using a ring-shaped application system with the following mixture:

| | |
|---|---|
| 50.0 kg | of water |
| 5.0 kg | of finely ground wheat bran (max. 200 μm) |
| 30.0 kg | of gelatin |
| 0.5 kg | of glyoxal |
| 1.0 kg | of ® Edenol B316 Spezial |
| 1.5 kg | of CMC (carboxymethylcellulose Na salt) and |
| 3.0 l | of isopropanol, |

and dried as described in example 1. Subsequently, butyl acrylate was applied hereon as a further layer and dried. The resulting casing was stuffed with liver sausage emulsion. The weight loss was 5%.

### EXAMPLE 5

A textile woven fabric made of a cotton/polyester mixture having a weight of 102 g/m² was formed into a tube having a diameter of 75 mm having overlapping longitudinal edges and coated on the outside using a ring-shaped doctor knife with a mixture of

| | |
|---|---|
| 50.0 kg | of water |
| 5.0 kg | of finely ground chalk |
| 30.0 kg | of gelatin |
| 0.5 kg | of glyoxal |
| 1.0 kg | of ® Edenol B316 Spezial |
| 1.5 kg | of CMC (carboxymethylcellulose Na salt) and |
| 3.0 l | of isopropanol, |

and dried as described in example 1. Subsequently a further layer was applied hereon having the following composition:

| | |
|---|---|
| 69.0 kg | of water |
| 1.8 kg | of glycerol |
| 4.5 kg | of KPS wax |
| 1.2 kg | of a 20% strength aqueous solution of |
| | isotridecylpolyethylene glycol ether (® Genapol |
| | X-080) |
| 43.5 kg | of a PVDC dispersion having about 55% solids |
| | fraction (® Ixan 554) |

and the resultant tube was dried again. The casing was stuffed with liver sausage emulsion. The weight loss was 2%.

### EXAMPLE 6

A fibrous nonwoven made of a cotton/polyester fiber mixture having a weight of 40 g/m² was coated by doctor knife application with a mixture of

| | |
|---|---|
| 30.0 kg | of DAC (desamidocollagen) |
| 3.0 kg | of cellulose (pulverulent) |
| 5.0 kg | of glycerol and |
| 1.0 kg | of ® Edenol B316 Spezial. |

After drying, the fibrous nonwoven thus coated had a weight of 78 g/m². The fibrous nonwoven was cut into webs having a width of 152 mm, which were then formed into tubes. The overlapping longitudinal edges were sewed to one another. The sausage casings produced in this manner were stuffed with raw meat sausage emulsion. They had a stuffing caliber of 48 mm.

1. A tubular food casing comprising a coated reinforcement,
wherein the coating, present on at least one side of said reinforcement, comprises at least one film-forming protein.

2. The food casing as claimed in claim 1, wherein the reinforcement is a consolidated nonwoven or spunbonded fabric, a woven fabric, loop-formingly knitted fabric, loop-drawingly knitted fabric, laid fabric or a porous film.

3. The food casing as claimed in claim 1, wherein the reinforcement is impregnated.

4. The food casing as claimed in claim 1, wherein the reinforcement comprises natural and/or artificial fibers.

5. The food casing as claimed in claim 1, wherein the reinforcement has a weight of 3 to 400 g/m².

6. The food casing as claimed in claim 1, wherein the protein comprises gelatin and/or collagen.

7. The food casing as claimed in claim 1, wherein the fraction of protein is 2.5 to 95% by weight, based on the total coating weight of the casing.

8. The food casing as claimed in claim 1, wherein the coating, in addition to at least one protein, comprises at least one further natural and/or synthetic polymer.

9. The food casing as claimed in claim 8, wherein the further natural or synthetic polymer is a poly-acrylate, polyvinyl acetate and/or a (co)polymer having units of vinyl acetate and/or units of saponified vinyl acetate (vinyl alcohol).

10. The food casing as claimed in claim 1, wherein the further natural or synthetic polymer is a primary plasticizer.

11. The food casing as claimed in claim 10, wherein the further natural or synthetic polymer is an alginate, a polyvinylpyrrolidone, a quaternary vinylpyrrolidone copolymer, a copolymer having units of vinylpyrrolidone, maleic anhydride, methyl vinyl ether, or a branched polysaccharide.

12. The food casing as claimed in claim 8, wherein the fraction of the at least one further natural and/or synthetic polymer is up to 50% by weight, based on the dry weight of the casing.

13. The food casing as claimed in claim 1, wherein the food casing comprises at least one compound which crosslinks the protein and thereby decreases or cancels its water solubility.

14. The food casing as claimed in claim 13, wherein the crosslinker is epoxidized linseed oil, a diketene having (C₁₀-C₁₈)alkyl radicals, caramel, tannin, a diepoxide, citral, an aziridine, glyoxal, glutardialdehyde and/or a polyamine-polyamide-epichlorohydrin resin.

15. The food casing as claimed in claim 1, wherein the food casing comprises dyes and/or pigments.

16. The food casing as claimed in claim 15, wherein the fraction of dyes and/or pigments is 0.5 to 12.0% by weight, based on the dry weight of the casing.

17. The food casing as claimed in claim 1, wherein the food casing additionally has at least one further layer which does not comprise protein.

18. The food casing as claimed in claim 17, wherein the further layer is a layer based on polyacrylate, polyvinyl acetate, polyvinylpyrrolidone, polyvinylidene chloride, polyvinyl chloride, polyvinyl alcohol, synthetic rubber, latex, silicone or any mixture thereof.

19. The food casing as claimed in claim 1, wherein the food casing is internally and/or externally impregnated.

20. The food casing as claimed in claim 1, wherein the food casing has one longitudinal seam.

21. A method for producing the food casing as claimed in claim 1, said method comprising (i) forming a flat-shaped support material having a predetermined width into a tube, (ii) charging the tube with supporting air to maintain its shape or holding the tube in a round shape by caliber support rings and (iii) seamlessly providing the tube internally and/or externally with protein-containing coating.

22. A method for producing the food casing as claimed in claim 1, said method comprising (i) coating a flat-shaped support material on one or both sides with protein-containing coating, (ii) cutting the coated support material if appropriate to appropriate width and (iii) forming the coated support material into a tube and, (iv) bonding the overlapping longitudinal edges of the coated support material firmly to one another.

23. An artificial sausage casing comprising the food casing as claimed in claim 1.

24. An artificial sausage casing as claimed in claim 24, which is used in shirred form as a shirred stick or in the form of individual sections, the individual sections being closed at one end by a metal or plastic clip, by tying with yarn or by sewing.

25. A food casing comprising fibrous material, said fibrous material derived from a flat fibrous material coated on one or both sides, wherein the coating is based on protein and is applied uniformly to the fibrous material.
